(19) United States
(12) Patent Application Publication
(10) Pub. No.: US 2017/0359357 A1
(43) Pub. Date: Dec. 14, 2017

(54) A METHOD AND APPARATUS FOR MANAGING A PREFERENCE SETTING FOR TRUST LEVEL INFORMATION OF CALLER IDENTITY IN A WIRELESS ACCESSS SYSTEM

(71) Applicant: LG Electronics Inc., Seoul (KR)

(72) Inventor: Ki-dong Lee, San Diego, CA (US)

(21) Appl. No.: 15/524,183

(22) PCT Filed: Nov. 4, 2015
(86) PCT No.: PCT/KR2015/011776

§ 371 Date: May 3, 2017

Related U.S. Application Data
(60) Provisional application No. 62/082,582, filed on Nov. 20, 2014.
(60) Provisional application No. 62/082,066, filed on Nov. 19, 2014.
(60) Provisional application No. 62/075,236, filed on Nov. 4, 2014.

(51) Int. Cl. H04L 29/06; H04W 12/12; H04M 1/67; H04M 1/57

(52) U.S. Cl. CPC H04L 63/12; H04W 12/12; H04L 63/1466; H04M 1/67; H04M 1/57

(57) ABSTRACT

The present invention relates to a wireless access system, and more particularly, to methods and apparatus for managing a preference setting for trust level information of caller identity. One of embodiments of the present application comprises steps of transmitting preference setting information of a user of the ME to the network, the preference setting information indicating whether or not the trust level information for an incoming call from a caller is to be delivered; and receiving a call message including the caller identifier of the caller, the call message being configured based on the preference information, wherein the call message further includes the trust level information when the preference setting information indicates the trust level information is to be delivered, or the call message dose not includes the trust level information when the preference setting information indicates the trust level information is not to be delivered.

### TECHNICAL FIELD

The present invention relates to a wireless access system, and more particularly, to methods and apparatus for managing a preference setting for trust level information of caller identity.

### BACKGROUND ART

A wireless communication system has been widely developed to provide various kinds of communication services such as voice and data. Generally, the wireless communication system is a multiple access system that can support communication with multiple users by sharing available system resources (bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

Regarding to a network security, a spoofing attack is a situation in which one person or program successfully masquerades as another by falsifying data and thereby gaining an illegitimate advantage.

As one of kinds of the spoofing attack, a caller identifier (ID) spoofing exists. That is, public telephone networks often provide caller ID information, which includes the caller's name and number, with each call. However, some technologies (especially in Voice over IP (VoIP) networks) allow callers to forge Caller ID information and present false names and numbers. Gateways between networks that allow such spoofing and other public networks then forward that false information. Since spoofed calls can originate from other countries, the laws in the receiver's country may not apply to the caller. This limits laws' effectiveness against the use of spoofed Caller ID information to further a scam.

Meanwhile, although the delivery and storage of trust level information of the calling party's identity are necessary, there would be some case that the terminating UE is interested or not interested in being notified of this trust level information. For example, it is assumed that a user sets a preference setting about the trust level information on the user's UE. After then, if the user changes the terminating UE to another UE or borrows another user's UE for many reasons, a preference setting on the changed UE or the borrowed UE can be different compared with the original setting on the terminating UE unless the user resets the preference setting on the changed UE or the borrowed UE.

### DETAILED DESCRIPTION OF THE INVENTION

### Technical Problems

To solve the problems described above, one object of the present invention is to provide methods how to manage the preference setting on the trust level information of caller identity.

Another object of the present invention is to provide methods that the terminating UE should be able to indicate to the terminating network whether or not to present the trust level information concurrent with call alerting. In this case, it is preferred that the terminating network shall be able to store the trust level information even if the terminating UE prefers not to receive the information.

Still another object of the present invention is to provide methods and apparatuses for preventing from spoofing by an unknown user.

Still another object of the present invention is to provide a mobile equipment (ME) and/or a base station apparatus for supporting the above-described methods.

Technical problems to be solved by the present invention are not limited to the above-mentioned technical problem, and other technical problems not mentioned above can be clearly understood by one skilled in the art from the following description.

### Technical Solutions

The present invention relates to a method and apparatus for managing a preference setting for trust level information of a caller identifier in a wireless access network.

In one aspect of the present invention, a method for managing preference setting information for trust level information of a caller identifier in a wireless access network, the method performed by a mobile equipment (ME) and comprising: transmitting preference setting information of a user of the ME to the network, the preference setting information indicating whether or not the trust level information for an incoming call from a caller is to be delivered; and receiving a call message including the caller identifier of the caller, the call message being configured based on the preference information, wherein the call message further includes the trust level information when the preference setting information indicates the trust level information is to be delivered, or the call message dose not includes the trust level information when the preference setting information indicates the trust level information is not to be delivered.

The preference setting information may be only stored in the network.

The ME may determine to display or not the trust level information according to the call message.

The method further comprises step of transmitting user information including an identifier of user to a network when the ME has been powered on, wherein the user information is stored in the network along with the preference setting information of the user.

The call message may be configured based on the user information along with the preference setting information of the user.

The trust level information may indicate one of (1) fully authenticated, (2) spoofed, or (3) not authenticated.

In another aspect of the present invention, a mobile equipment (ME) for managing preference setting information for trust level information of a caller identifier in a wireless access network, the ME comprising a transmitter; a receiver; and a processor connected with the transmitter and the receiver for managing the preference information. The processor may be configured to: transmit preference setting information of a user of the ME to the network by controlling the transmitter, the preference setting information indicating whether or not the trust level information for an incoming call from a caller is to be delivered; and receive a call message including the caller identifier of the caller by controlling the receiver, the call message being configured based on the preference information. In this case, the call message may further include the trust level information when the preference setting information indicates the trust level information is to be delivered, or the call message dose not includes the trust level information when the preference setting information indicates the trust level information is not to be delivered.

The preference setting information may be only stored in the network.

The processor may determine to display or not the trust level information according to the call message.

The processor may be further configured to transmit user information including an identifier of user to a network when the ME has been powered on by controlling the transmitter, wherein the user information is stored in the network along with the preference setting information of the user.

The call message may be configured based on the user information along with the preference setting information of the user.

The trust level information may indicate one of (1) fully authenticated, (2) spoofed, or (3) not authenticated.

Or, the trust level information can be configured as multiple-level information: for example, it is (1) fully authenticated caller ID with the caller ID integrity-protected, (2) authenticated caller ID with no caller ID integrity-protected or caller ID spoofed (i.e., negatively authenticated caller ID), or (3) not authenticated caller ID.

The above embodiments are part of preferred embodiments of the present invention. Obviously, it is to be understood to those having ordinary knowledge in the art that various embodiments having the technical features of the present invention can be implemented on the detailed description of the present invention as set forth herein.

### Advantageous Effects

According to exemplary embodiments of the present invention, the following advantages can be obtained.

First of all, the present inventions are able to effectively manage the preference setting of the users.

Second of all, even the user changes the ME to another, the preference setting for the trust level information according to the preference setting information can be automatically applied without resetting of the preference information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates a schematic structure a network structure of an evolved universal mobile telecommunication system (E-UMTS);

FIG. 2 illustrates a schematic structure of an Evolved Universal Terrestrial Radio Access Network (E-UTRAN);

FIG. 3 illustrates the configurations of a radio interface protocol between the E-UTRAN and a UE;

FIG. 4 illustrates contractures of the IMSI and the GUTI.

FIG. 5 illustrating a method for notifying trust level information of an incoming call.

FIG. 6 illustrates methods for displaying the trust level information according to the preference setting on ME.

FIG. 7 illustrates a method for setting preference setting information for the trust level information in the network.

FIG. 8 illustrates another method for setting preference setting information for the trust level information in the network.

FIG. 9 shows apparatuses for implementing the above-mentioned methods described with reference to FIGS. 1 to 8.

### BEST MODE FOR CARRYING OUT THE INVENTION

Exemplary embodiments of the present invention provide a method and apparatus for notifying authenticity information of caller identity.

The embodiments of the present invention described below are combinations of elements and features of the present invention in specific forms. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or elements of any one embodiment may be included in another embodiment and may be replaced with corresponding constructions or features of another embodiment.

In the description of the attached drawings, a detailed description of known procedures or steps of the present invention will be avoided lest it should obscure the subject matter of the present invention. In addition, procedures or steps that could be understood by those skilled in the art will not be described either.

In the embodiments of the present invention, a description has been mainly made of a data transmission and reception relationship between a BS and a UE. A BS refers to a terminal node of a network, which directly communicates with a UE. A specific operation described as being performed by the BS may be performed by an upper node of the BS.

Namely, it is apparent that, in a network comprised of a plurality of network nodes including a BS, various operations performed for communication with a UE may be performed by the BS, or network nodes other than the BS. The term ‘BS’ may be replaced with a fixed station, a Node B, an eNode B (eNB), an ABS (Advanced Base Station), an access point, etc.

The term UE may be replaced with the terms MS (Mobile Station), a SS (Subscriber Station), a MSS (Mobile Subscriber Station), an AMS (Advanced Mobile Station), a MT (Mobile Terminal) and a ME (Mobile Equipment), etc. Especially, it should be noted that the terms ‘eNB’ and ‘eNode-B’ are used interchangeably and the terms ‘UE’ and ‘ME’ are interchangeably used in the embodiments of the present invention.

A transmitter is a fixed and/or mobile node that provides a data or voice service and a receiver is a fixed and/or mobile node that receives a data or voice service. Therefore, an UE may serve as a transmitter and a BS may serve as a receiver, on uplink. Likewise, the UE may serve as a receiver and the BS may serve as a transmitter, on downlink.

The embodiments of the present invention are supported by standard documents disclosed for at least one of wireless access systems including IEEE 802.xx systems, a 3GPP system, a 3GPP LTE system, and a 3GPP2 system. In particular, the embodiments of the present invention are supported by 3GPP TS 22.898, 3GPP TS 36.211, 3GPP TS 36.212, 3GPP TS 36.213, 3GPP TS 36.321, and 3GPP TS 36.331 documents. The steps or parts, which are not described to clearly reveal the technical idea of the present invention, in the embodiments of the present invention may be supported by the above documents. All terms used in the embodiments of the present invention may be explained by the standard documents.

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. Specific terms used for the embodiments of the present invention are provided to aid in understanding of the present invention. These specific terms may be replaced with other terms within the scope and spirit of the present invention.

The embodiments of the present invention may be used in various wireless access technologies, such as CDMA (Code Division Multiple Access), FDMA (Frequency Division Multiple Access), TDMA (Time Division Multiple Access), OFDMA (Orthogonal Frequency Division Multiple access), and SC-FDMA (Single Carrier Frequency Division Multiple Access).

CDMA may be implemented with radio technology such as UTRA (Universal Terrestrial Radio Access) or CDMA2000. TDMA may be implemented with radio technology such as GSM (Global System for Mobile communications)/GPRS (General Packet Radio Service)/EDGE (Enhanced Data Rates for GSM Evolution). OFDMA may be implemented with radio technology such as IEEE 802.11 (Wi-Fi), IEEE 802.16 (WiMAX), IEEE 802.20, and E-UTRA (Evolved UTRA).

UTRA is part of a UMTS (Universal Mobile Telecommunications System). 3GPP LTE is a part of Evolved UMTS (E-UMTS), which uses E-UTRA. 3GPP LTE employs OFDMA on downlink and uses SC-FDMA on uplink. LTE-A (Advanced) is an evolved version of 3GPP LTE. The following embodiments of the present invention mainly describe examples of the technical characteristics of the present invention as applied to the 3GPP LTE/LTE-A systems.

1. An Overall of 3GPP LTE/LTE-A Systems

In a wireless access system, a UE receives information from a BS through a downlink and transmits information to the BS through an uplink. Information transmitted and received between the UE and the BS includes general data information and control information. A variety of physical channels are provided according to type/use of information transmitted and received between the UE and the BS.

1.1 System Architecture

FIG. 1 illustrates a schematic structure a network structure of an evolved universal mobile telecommunication system (E-UMTS). An E-UMTS system is an evolved version of the WCDMA UMTS system and basic standardization thereof is in progress under the 3rd Generation Partnership Project (3GPP). The E-UMTS is also referred to as a Long Term Evolution (LTE) system. For details of the technical specifications of the UMTS and E-UMTS, refer to Release 7 and Release 8 of “3rd Generation Partnership Project; Technical Specification Group Radio Access Network”. In these days, an evolved system of the 3GPP LTE has been appeared and it is referred as 3GPP LTE-A (3GPP LTE advanced) system. Details of the technical specifications of the 3GPP LTE-A system are referred to Releases 9 to 12.

Referring to FIG. 1, the E-UMTS mainly includes a User Equipment (UE), base stations (or eNBs or eNode Bs), and an Access Gateway (AG) which is located at an end of a network (e.g., E-UTRAN) and which is connected to an external network. Generally, an eNB can simultaneously transmit multiple data streams for a broadcast service, a multicast service and/or a unicast service.

The AG can be divided into a part that handles processing of user traffic and a part that handles control traffic. Here, the AG part for processing new user traffic and the AG part for processing control traffic can communicate with each other using a new interface. One or more cells may be present for one eNB. An interface for transmitting user traffic or control traffic can be used between eNBs.

A Core Network (CN) may include the AG and a network node or the like for user registration of UEs. An interface for discriminating between the E-UTRAN and the CN can be used. The AG manages mobility of a UE on a Tracking Area (TA) basis. One TA includes a plurality of cells. When the UE has moved from a specific TA to another TA, the UE notifies the AG that the TA where the UE is located has been changed.

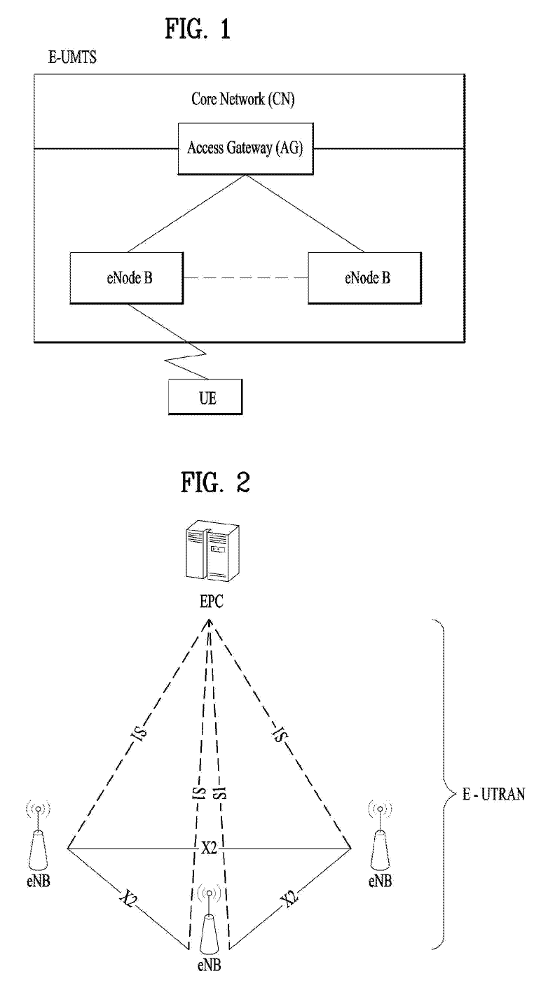

FIG. 2 illustrates a network structure of an Evolved Universal Terrestrial Radio Access Network (E-UTRAN) system. The E-UTRAN system is an evolved version of the conventional UTRAN system. The E-UTRAN includes base stations that will also be referred to as “eNode Bs” or “eNBs”.

The eNBs are connected through X2 interfaces. The X2 user plane interface (X2-U) is defined between eNBs. The X2-U interface provides nonguaranteed delivery of user plane PDUs. The X2 control plane interface (X2-CP) is defined between two neighbor eNBs. The X2-CP performs following functions: context transfer between eNBs, control of user plane tunnels between source eNB and target eNB, transfer of handover related messages, uplink load management and the like.

Each eNB is connected to User Equipment (UE) through a radio interface and is connected to an Evolved Packet Core (EPC) through an S1 interface. The S1 user plane interface (S1-U) is defined between the eNB and the S-GW. The S1-U interface provides nonguaranteed delivery of user plane PDUs between the eNB and the S-GW (Serving Gateway). The S1 control plane interface (e.g., S1-MME) is defined between the eNB and the MME (Mobility Management Entity). The S1 interface performs following functions: EPS (Evolved Packet System) Bearer Service Management function, NAS (Non-Access Stratum) Signaling Transport function, Network Sharing Function, MME Load balancing Function and the like.

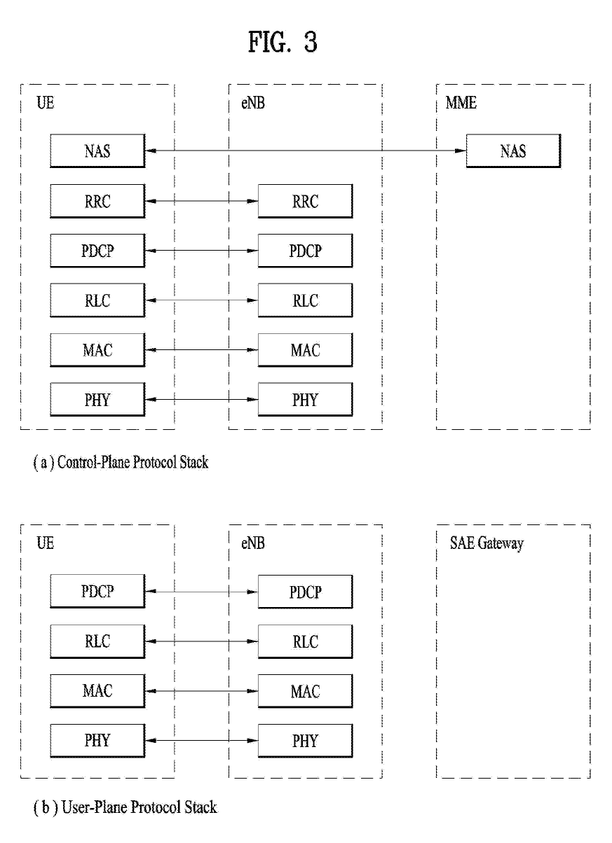

FIG. 3 illustrates the configurations of a control plane and a user plane of a radio interface protocol between the E-UTRAN and a UE based on the 3GPP radio access network standard. The radio interface protocol is divided horizontally into a physical layer, a data link layer, and a network layer, and vertically into a user plane for data transmission and a control plane for signaling. The protocol layers of FIG. 3 can be divided into an L1 layer (first layer), an L2 layer (second layer), and an L3 layer (third layer) based on the lower three layers of the Open System Interconnection (OSI) reference model widely known in communication systems.

The control plane is a passage through which control messages that a UE and a network use in order to manage calls are transmitted. The user plane is a passage through which data (e.g., voice data or Internet packet data) generated at an application layer is transmitted. The following is a detailed description of the layers of the control and user planes in a radio interface protocol.

The physical layer, which is the first layer, provides an information transfer service to an upper layer using a physical channel The physical layer is connected to a Media Access Control (MAC) layer, located above the physical layer, through a transport channel. Data is transferred between the MAC layer and the physical layer through the transport channel Data transfer between different physical layers, specifically between the respective physical layers of transmitting and receiving sides, is performed through the physical channel The physical channel is modulated according to the Orthogonal Frequency Division Multiplexing (OFDM) method, using time and frequencies as radio resources.

The MAC layer of the second layer provides a service to a Radio Link Control (RLC) layer, located above the MAC layer, through a logical channel The RLC layer of the second layer supports reliable data transmission. The functions of the RLC layer may also be implemented through internal functional blocks of the MAC layer. In this case, the RLC layer need not be present. A PDCP layer of the second layer performs a header compression function to reduce unnecessary control information in order to efficiently transmit IP packets such as IPv4 or IPv6 packets in a radio interface with a relatively narrow bandwidth.

A Radio Resource Control (RRC) layer located at the bottom of the third layer is defined only in the control plane and is responsible for control of logical, transport, and physical channels in association with configuration, re-configuration, and release of Radio Bearers (RBs). The RB is a service that the second layer provides for data communication between the UE and the E-UTRAN. To accomplish this, the RRC layer of the UE and the RRC layer of the network exchange RRC messages. The UE is in an RRC connected mode if an RRC connection has been established between the RRC layer of the radio network and the RRC layer of the UE. Otherwise, the UE is in an RRC idle mode.

A Non-Access Stratum (NAS) layer located above the RRC layer performs functions such as session management and mobility management.

One cell of the eNB is set to use a bandwidth such as 1.25, 2.5, 5, 10 or 20 MHz to provide a downlink or uplink transmission service to UEs. Here, different cells may be set to use different bandwidths.

Downlink transport channels for transmission of data from the network to the UE include a Broadcast Channel (BCH) for transmission of system information, a Paging Channel (PCH) for transmission of paging messages, and a downlink Shared Channel (SCH) for transmission of user traffic or control messages. User traffic or control messages of a downlink multicast or broadcast service may be transmitted through a downlink SCH and may also be transmitted through a downlink multicast channel (MCH). Uplink transport channels for transmission of data from the UE to the network include a Random Access Channel (RACH) for transmission of initial control messages and an uplink SCH for transmission of user traffic or control messages.

Logical channels, which are located above the transport channels and are mapped to the transport channels, include a Broadcast Control Channel (BCCH), a Paging Control Channel (PCCH), a Common Control Channel (CCCH), a Multicast Control Channel (MCCH), and a Multicast Traffic Channel (MTCH).

1.2 Location Registration

A Public Land Mobile Network (PLMN) is a network established and operated by an Administration or a RPOA (Recognized Private Operating Agency) for the specific purpose of providing land mobile communication services to the public. The PLMN provides communication possibilities for mobile users. For communication between mobile and fixed users, interworking with a fixed network is necessary. Therefore, PLMNs shall provide a location registration function with the main purpose of providing continuity of service to UEs over the whole system area. The location registration function shall be such as to allow:

Fixed subscribers to call a UE by only using the directory number of the UE irrespective of where the UE is located in the system area at the time of the call.

UEs to access the system irrespective of the location of the UE.

UEs to identify when a change in location area has taken place in order to initiate automatic location updating procedures.

2. User Control Over Spoofed Calls

Spoofing or malicious modification of caller information to hide the real caller identity provided by such capabilities as Calling Line Identification and Caller Name (Caller ID) is growing into a significant problem in many countries. The complaints to authorities and PLMN operators regarding these spoofed calls range from nuisance calls, violations of various phone solicitation rules (such as the US Federal Trade Commission's Telemarketing Sales Rules) to being used as a platform for significant fraud, identity theft and social engineering. Various malicious uses of caller information spoofing include these categories: swatting, vishing (voice phishing), smishing (SMS phishing), and TDOS (Telephony Denial-of-service).

There are several SDOs dealing with creating the ability to detect caller information spoofing within call setup signaling including IETF's Stir working group, 3GPP's SA3 and ATIS's PTSC CSEC. However their focus is to define automated mechanisms to identify whether the caller information is authentic and the caller is authorized to use the presented caller information. What can be done with the calls where the caller information is determined to be unauthorized or unauthentic is not addressed in these activities.

2.1 User Identifiers

In LTE/LTE-A system, different IDs are used to identify each entity depending on their relationship with other IDs. For example, LTE/LTE-A systems define user equipment identifiers (UE IDs), such as IMSI (International Mobile Subscriber Identity), GUTI (Globally Unique Temporary UE Identity), S-TMSI (SAE Temporary Mobile Subscriber Identity), IP (Internet Protocol) address, and/or C-RNTI (Cell-Radio Network Temporary Identity) used for identifying the UE. Hereinafter, the UE IDs which can be used in the embodiments of the present application will be explained in detail.

The IMSI is a unique number associated with each mobile phone user. It is stored in the SIM (Subscriber Identity Module) inside the phone and is sent by the phone to the network. It is primarily intended for obtaining information on the use of the PLMN by subscribers. It is also used for other functions such as to compute the Paging Occasions (PO) in LTE/LTE-A system.

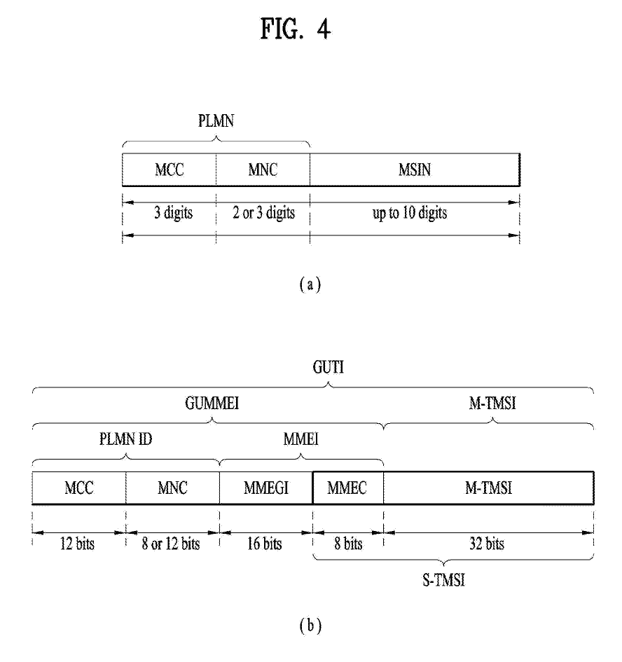

In this case, the IMSI is composed of two parts, PLMN ID and MSIN (Mobile Subscriber Identification Number), as shown in FIG. 4. FIG. 4 illustrates contractures of the IMSI and the GUTI.

Referring to FIG. 4(a), a PLMN ID is an ID that globally identifies a mobile operator (e.g. combination of a MCC (Mobile Country Code) and a MNC (Mobile Network Code)). The MSIN is a unique ID that identifies a mobile subscriber within a mobile operator. When a user subscribes to a mobile network (e.g., the LTE/LTE-A systems), the user gets a device and a USIM (Universal Subscriber Identity Module) card (or, a SIM card) that has an IMSI in it. By then, the LTE network should already have the same IMSI registered as well. IMSIs are stored in an HSS (Home Subscriber Server) and an SPR which are the LTE entities.

In the HSS, a key to be used along with the IMSI in authenticating subscribers, and QoS profile to be used by the user are stored. So, when users attempt to access (i.e. who send Attach Request message) to the network, the HSS (the MME on behalf of the HSS, to be accurate) denies the users with an unregistered IMSI, but allows ones with a valid registered IMSI by delivering authentication information and QoS profile to the MME.

Referring to FIG. 4(b), the GUTI is an unambiguous identification of the UE that does not reveal the UE or the user's permanent identity in the EPS. It also allows the identification of the MME and network. It can be used by the network and the UE to establish the UE's identity during signaling between them in the EPS.

The IMSI is one of the most important parameters that identify a subscriber. So, if it is exposed over radio link, serious security problem can be caused. So, to keep an IMSI secure, an alternate value that a subscriber (e.g., the UE) can use instead of the IMSI (whenever possible) to access the LTE network was needed. That is why GUTI is used. Unlike an IMSI, a GUTI is not permanent and is changed into a new value whenever generated.

When a UE initially attaches to an LTE network (e.g. turning on the UE), it sends its IMSI to the network for authentication to have itself identified. In other words, it uses the IMSI as its ID. Once connection is established (i.e., once successfully authenticated), the network (e.g., the MME) delivers a GUTI value through an Attach Accept message to the UE, which then remembers the value to use it as its ID instead of the IMSI when it re-attaches to the network (i.e., when it is turned off and then on again later).

Referring back to FIG. 4(b), the GUTI consists of the GUMMEI (Globally Unique Mobility Management Entity Identifier) and the M-TMSI (M Temporary Mobile Subscriber Identity). The GUMMEI is used to identify the MME uniquely in global. The GUMMEI consists of a PLMN identity, an MMEGI (MME Group Identity) and an MMEC (MME Code). The MME code is used in the eNodeB by the NAS node selection function to select the MME. In addition, the M-TMSI is a temporary identity used to preserve subscriber confidentiality. It identifies a user between the UE and the MME. The relationship between M-TMSI and the IMSI is known only in the UE and in the MME.

The S-TMSI (System Architecture Evolution—Temporary Mobile Subscriber Identity) is a unique identifier assigned to the UE by the MME in order to identify the UE context while supporting subscriber identity confidentiality. Referring to FIG. 4(b), the S-TMSI consists of MMEC and the M-TMSI.

As one of the UE IDs, the IP address, also called as a “PDN (Packet Data Network) address” is allocated by an LTE network to a UE in order for the UE to connect to a PDN (i.e., an IP network) when the UE initially attaches to the LTE network. Because a UE can be connected to more than one PDN through an LTE network depending on the services, the LTE network allocates each UE a different IP address per each PDN the UE is connected to. These IP addresses (PDN addresses) are used to identify the UE from/to which an IP packet is sent when the IP packet is forwarded from an LTE network to a PDN, or received from a PDN.

The C-RNTI is allocated to a UE by an eNB through a random access procedure in a cell controlled by the eNB and is effective only within the serving cell. UEs in the cell are uniquely identified by their C-RNTI. A new C-RNTI is allocated when the UE leaves the current cell and moves to a new cell through a random access procedure.

2.2 Caller ID

A Caller ID (caller identification) which is used in embodiments of the present invention can be also called a calling line identification (CLID), a calling number delivery (CND), a calling number identification (CNID), a calling line identification presentation (CLIP) or a Mobile Station International Subscriber Directory Number (MSISDN). The caller ID is used in a telephone service, available in analog and digital phone systems and most voice over Internet Protocol (VoIP) applications.

In the telephone service, it transmits a caller's number to the called party's telephone equipment (e.g., user equipment) during the ringing signal, or when the call is being set up but before the call is answered. Where available, caller ID can also provide a name associated with the calling telephone number. This service is called a Calling Name Delivery Service (CNAM). The information made available to the called party may be displayed on a telephone's display, on a separately attached device, or personal computer.

The caller ID may be used by the recipient to avoid answering unwanted incoming calls by the concept of informed consent; however, it also poses problems for personal privacy. The possibility of caller ID spoofing may render received information unreliable.

In 3GPP system studies FS_UC_SPOOF (Feasibility study for User control on Spoofed calls) cases. At this time, there are three types of use cases studied so far. However, there are some cases that can create confusion for the user who is receiving an incoming call, regarding whether the caller ID is delivered after it is authenticated or not.

In this document, the meaning of authentication procedure includes verifying the caller ID is spoofed or not. Hereinafter, embodiments of the present invention providing a caller ID authenticity will be described.

2.3. Methods for Notifying Authenticated Status of Caller ID

In providing the authenticity of a caller ID to a callee (who receives the call), the caller's network may have two possibilities: (1) being capable of providing authenticity or (2) not being capable.

When the caller's network is not capable of providing authenticity of the caller's ID, the callee may have confusions about the received caller ID information whether it is not spoofed ID (i.e., authenticated one) or it is a spoof caller ID provided by non-authenticating network. Therefore, it is not enough to provide an indication that the caller's ID is authenticated.

Accordingly, the embodiments of the present application provide methods for notifying the trust level information of an incoming call from another network.

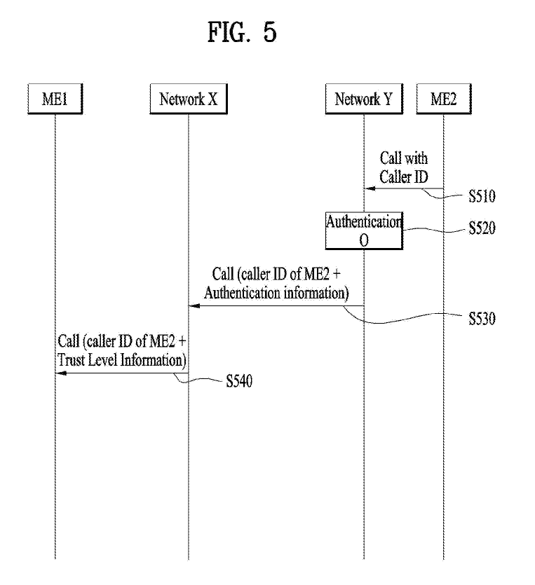

FIG. 5 illustrating a method for notifying trust level information of an incoming call.

It is assumed that the Network X is a PLMN which employs automated spoofed call detection and the Network Y is a PLMN which employs automated spoofed call detection. In this case, each of the Network X and the Network Y includes one or more an evolved Node B (eNB), a mobility management entity (MME), a serving gate way (S-GW), a paging gate way (P-GW), and one or more mobile equipment (ME). In addition, the Network X can be referred to a first network and the Network Y can be referred to a second network.

It is assumed that Alice is a user of the ME1 which has been subscribed in the Network X. Bob is a user of the ME2 which has been subscribed in the Network Y. In this case, Bob wishes to call to Alice which is in the different network or different country. So, the ME2 of Bob attempts to call Alice with a Bob's caller ID through the Network Y. The caller ID can be the MSISDN that is a telephone number of the ME2 (S510).

The Network Y performs an authentication procedure based on the caller ID of Bob. In this case, the ME2 has been already subscribed in the Network Y, so the Network Y has identification information of the ME2. Accordingly, the Network Y is able to authenticate whether the caller ID is authentic or not by comparing the identification information and the caller ID of the ME2. In this case, the identification information of the ME2 can be one or combination of UE IDs described in section 2.1 (S520).

During the authentication procedure, the Network Y may authenticate whether the incoming call is spoofed or not by comparing the UE ID with the caller ID. So, if the caller ID is not matched with the UE ID, the Network Y decides the call has been spoofed. On the other hand, if the caller ID is matched with the UE ID, the Network Y decides the call has authenticity.

After the authentication procedure was performed, the Network Y transfers the call message from the ME2 to the UE1 of Alice in the Network X. In this case, the Network Y also notifies the authentication information derived at the step 5520 with the caller ID of the ME2. In addition, the Network Y notifies the types/attributes of Bob's caller ID that will be released to Alice and/or Alice's Network for the purpose of providing the authenticity information (S530).

If the Network X has been received the call message, the Network X determines whether the caller ID of the ME2 has been authenticated or not by detecting the authenticity information in the call message.

After then, the network X delivers Bob's caller ID and the trust level information indicating an authenticity level of Bob's caller ID. In this case, the trust level information is able to indicate one of authenticity levels such as an authenticated, a spoofed or an unauthenticated (S540).

By receiving the trust level information along with the caller ID of the ME2, the ME1 of Alice is able to recognize whether the call from the Bob is spoofed or not. In other aspect of the embodiments, if the trust level information indicates the unauthenticated, the meaning of the unauthenticated is that the authenticity is not verified yet and authentication has not been provided to the incoming call from the other network.

In other aspect of the present invention, the trust level information can be configured as multiple-level information: for example, it is (1) fully authenticated with the caller ID integrity-protected (i.e., fully authenticated), (2) authenticated caller ID with no caller ID integrity-protected (i.e., negatively authenticated caller ID or spoofed), or (3) not authenticated.

3. Preference Setting for The Trust Level Information

3.1 Scenarios on Preference Setting in ME

Hereinafter, the scenarios on preference setting in mobile devices (i.e., ME) are described.

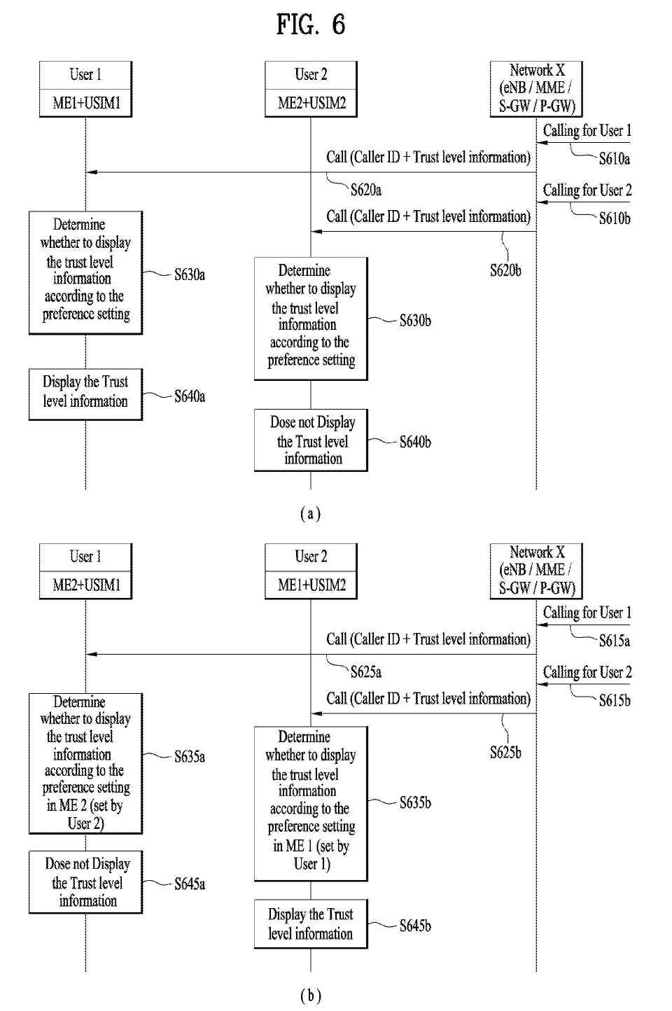

FIG. 6 illustrates methods for displaying the trust level information according to the preference setting on ME.

The user 1 (e.g., Alice) and user 2 (e.g., Bob) are able to set preference for the trust level information delivered from the network X on their MEs. For example, the user 1 sets her preference “On” in her ME1 to display the trust level information and the user 2 sets his preference “Off” in his ME2 to not display the trust level information. In this case, the USIM1 is belonging to the user 1 and the USIM2 is belonging to the user 2 and the USIMs can be extracted and inserted to another ME. The USIMs contain one or more user identifiers and caller IDs described in sections 2.1 and 2.2.

Referring to FIG. 6 (a), when the calling for the user 1 is come from another network to the network X (S610a), the network X transmits the call message including a caller ID and trust level information about the call (S620a).

The ME1 of the user 1 receiving the call message determines whether to display the trust level information according to the preference setting by the user 1 (S630a).

The ME1 displays the trust level information because the preference setting of the user 1 is “On” (S640a).

In addition, when the calling for the user 2 is come from another network to the network X (S610b), the network X transmits the call message including a caller ID and trust level information about the call (S620b).

The ME2 of the user 2 receiving the call message determines whether to display the trust level information according to the preference setting by the user 2 (S630b).

The ME2 does not display the trust level information because the preference setting of the user 1 is “Off” (S640b).

The terminating network X keeps sending the trust level information but the displaying the trust level information is determined according to the preference setting on his/her MEs. Under this situation, it is assumed that user 1 extracts her USIM1 from the ME1 and lends ME1 to user 2 and user 2 extracts his USIM2 from the ME2 and lends ME2 to user 1.

Referring to FIG. 6 (b), when user 1 (i.e., Alice) has an incoming call from the network X with caller identity spoofing detection (S615a, S625a), the ME2 that user 1 is using with her USIM1 will do not display the trust level information of her caller, not based on her own preference setting but based on user 2's preference setting (S635a, S645a).

In addition, when user 2 (i.e., Bob) has an incoming call from the network X with caller identity spoofing detection (S615b, S625b), the ME1 that user 2 is using with his USIM2 will display the trust level information of his caller, not based on his own preference setting but based on user 1 preference setting (S635b, S645b).

This is because the displaying the trust level information is dependent on the preference setting in the mobile devices (i.e., the MEs). Accordingly, the user of the ME is unintentionally notified the trust level information or does not notified contrary to the user's own setting when the preference setting is only stored and managed by the MEs.

By getting the terminating network aware of the user's preference, these problems can be avoided, as described in following sections. Also, for “dumb” wireless cell phones, the support of user presentation preference will need to be handled by the network.

3.2 Scenarios on Preference Setting in Network

Hereinafter, the scenarios on preference setting in network are described.

The terminating ME' s is able to set their preference to the terminating network whether or not to receive caller identification and trust level information determined by the terminating networks call spoofing detection capability. The terminating network is able to utilize the trust level information even if the terminating ME prefers not to receive the information concurrently with call alerting.

When the terminating network (i.e., the network X) supports the presentation of the calling number or caller identity verification (i.e., the trust level information) concurrently with call alerting, there is a need for the user to configure the preference setting whether or not, it wants to be presented the trust level information to the called party. If the user has a service setting not to receive the trust level, the network is aware of the setting and does not send the trust level information to the terminating UE for presentation.

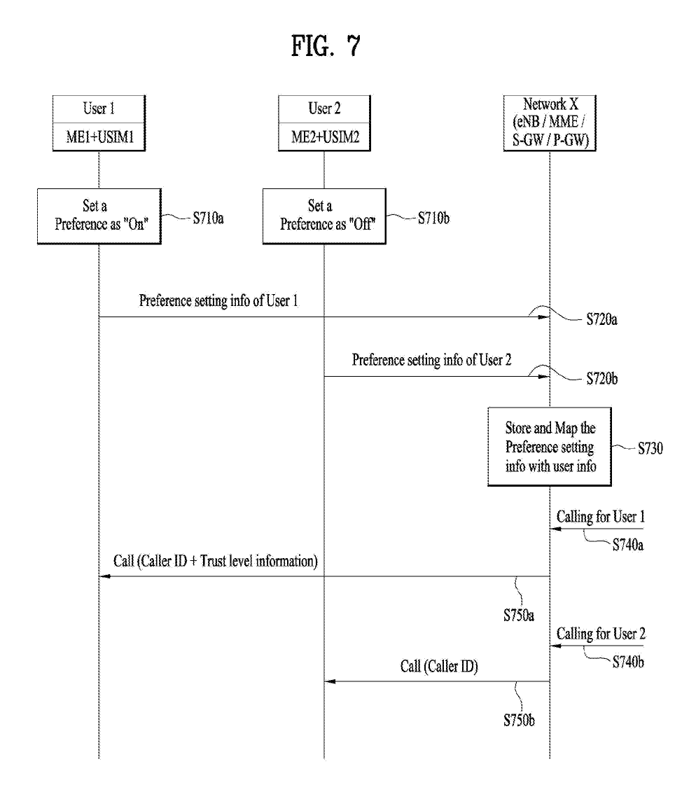

FIG. 7 illustrates a method for setting preference setting information for the trust level information in the network.

In FIG. 7, it is assumed that the Network X is a PLMN which employs automated spoofed call detection. In this case, the Network X provides its users with the ability to control the presentation of the results of the spoofed call detection concurrently with call alerting through a service setting. In addition, the Network X has the ability to indicate to user 1 (i.e., Alice) and user 2 (i.e., Bob) at call alerting the automated spoofed call detection service's trust of the claim by the caller as to their identity in the form of the calling number (e.g., the caller ID).

Besides, the user 1 and user 2 are subscribers of the Network X. The user 1 has the ME1 and her USIM1 is put into ME1 and the user 2 has ME2 and his USIM2 is put into ME2. Each of the USIM1 and the USIM2 includes user information of the user 1 and user 2, respectively. The user information may contain the user identifier (refer to section 2.1) and the caller identifier (refer to section 2.2).

Under these assumptions, referring to FIG. 7, the user 1 sets her spoofed call detection presentation service setting “ON” for the notification of the trust level information of caller's identity (S710a), but the user 2 sets his spoofed call detection presentation service setting “OFF” for the notification of trust level information of caller's identity (S710b).

After setting the preference for the trust level information, the ME1 and ME2 transmits preference setting information of user 1 or user 2 to the network X. The preference setting information field may consists of an indication on whether or not the trust level information to be delivered by the serving network X to the ME (i.e., callee). In this case, the indication can set as 1 bit and if the indication is set to ‘1’, the indication indicates transmitting the trust level information or if the indication is set to ‘0’, the indication indicates that do not transmit the trust level information (S720a, S720b).

The network X receiving the preference setting information of user 1 and user 2 stores each of the preference setting information of the users. In addition, the network X manages the preference setting information along with user information (e.g., USIM information, subscriber ID, etc.) representing the identification of the user. For example, the network X maps the preference setting information of the user 1 to the user information of the user 1 and maps the preference setting information of the user 2 to the user information of the user 2 (S730).

When the network X has an incoming call to the user 1 (i.e., Alice), the network X performs automated spoofed call detection verifies that the caller's calling number (i.e., the caller ID) is authenticated or not. And then, the network X transmits a call message with a caller ID of the incoming call and the trust level information according to the mapping of the preference setting information and the user information of the user 1 (S740a, S750a).

In addition, when the network X has an incoming call to the user 2 (i.e., Bob), the network X performs automated spoofed call detection verified that the caller's calling number is authenticated or not. And then, the network X transmits a call message only with a caller ID of the incoming call according to the mapping of the preference setting information and the user information of the user 2 (S740b, S750b).

After receiving the call message including the caller ID and the trust level information, the ME1 displays the caller ID and the trust level information for the user 1 so that the user 1 is able to decide to answer the call based on the caller ID and the trust level information. In addition, after receiving the call message including the caller ID, the ME2 displays the caller ID for the user 2.

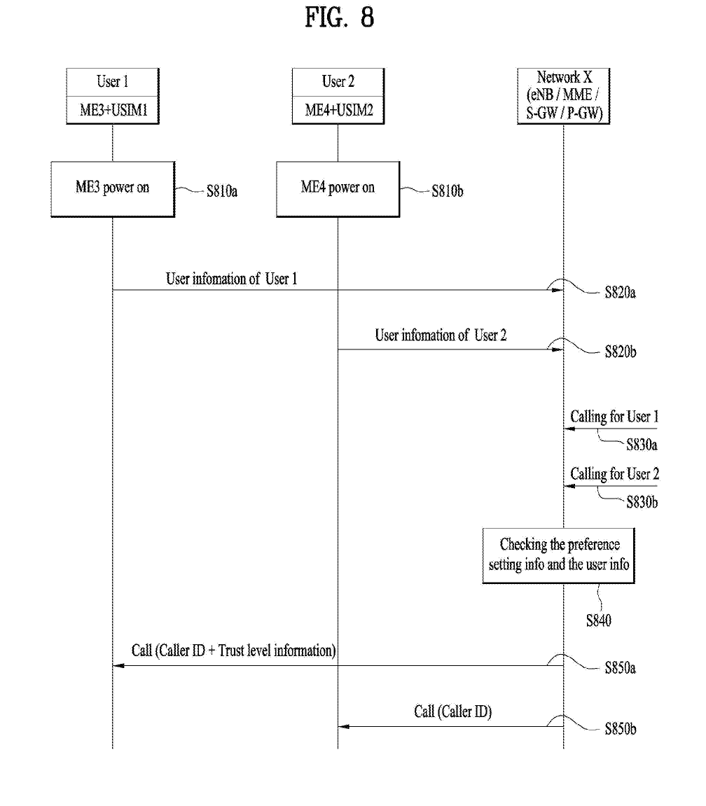

FIG. 8 illustrates another method for setting preference setting information for the trust level information in the network.

The terminating network X is able to transmit the trust level information according to the preference setting information which has been stored in the network X. In addition, basic assumptions applied to FIG. 8 are based on those of FIG. 7. Under this situation, it is assumed that user 1 extracts her USIM1 from the ME1 and inserts it to ME3 which has borrowed from other user or newly bought, and the user 2 extracts his USIM2 from the ME2 and inserts it to ME4 which has borrowed from other user or newly bought.

After inserts the USIMs to ME3 and ME4, the user 1 and 2 power on of the ME3 and ME4, respectively (S810a, S810b).

Each of the ME3 and the ME4 transmits the user information (e.g., the USIM information, subscriber ID, etc.) of the user 1 and user 2 to the network X (S820a, S820b).

If the network X receives the user information from the ME3 and the ME4, the network X is able to re-map the user information and the preference setting information previously stored in the network X (unshown).

When the network X has an incoming call to the user 1 (i.e., Alice) or the user 2 (i.e., Bob), the network X performs automated spoofed call detection verifies that the caller's calling number (i.e., the caller ID) is authenticated or not (S830a, S830b).

The network X checks the preference setting information with the user information delivered from each of the ME3 and ME4 (S840).

And then, the network X transmits a call message with a caller ID of the incoming call and the trust level information according to the mapping of the preference setting information and the user information of the user 1. Therefore, the user 1 is able to keep receiving the trust level information of incoming calls according to the preference setting information stored in the network X without resetting the preference setting even the ME1 used by the user 1 has been changed to other ME (e.g., the ME3) (S850a).

In addition, the network X transmits a call message only with a caller ID of the incoming call according to the mapping of the preference setting information and the user information of the user 2. Therefore, the user 2 is able to keep not receiving the trust level information of incoming calls according to the preference setting information stored in the network X without resetting the preference setting even the ME2 used by the user 2 has been changed to other ME (e.g., the ME4) (S850b).

In one aspect of the embodiment described on FIG. 8, the preference setting information is only stored in the network X and does not stored each of the MEs.

In another aspect of the embodiment described on FIG. 8, even the ME3 and the ME4 has preference setting for the trust level information, the ME3 and the ME4 display or not according to the contents included in the call message. That is, the ME3 and ME4 put priority on the call message and they merely display or not the trust level information according to the call message.

According to the embodiments of the present invention, the terminating network X will determine whether or not, to present the trust level information of the caller's claimed identity to the terminating MEs according to its spoofed call detection presentation service setting in the network X. Any restriction of trust level information does not affect any other aspects of spoofed call handling, such as call treatment, recording of spoofed call information or the ability to indicate a call is spoofed by the user. In addition, the terminating network X shall be able to accommodate the terminating user's preference (service setting) on the presentation of trust level information for incoming calls concurrently with call alerting.

4. Apparatuses for Implementing The Aforementioned Methods

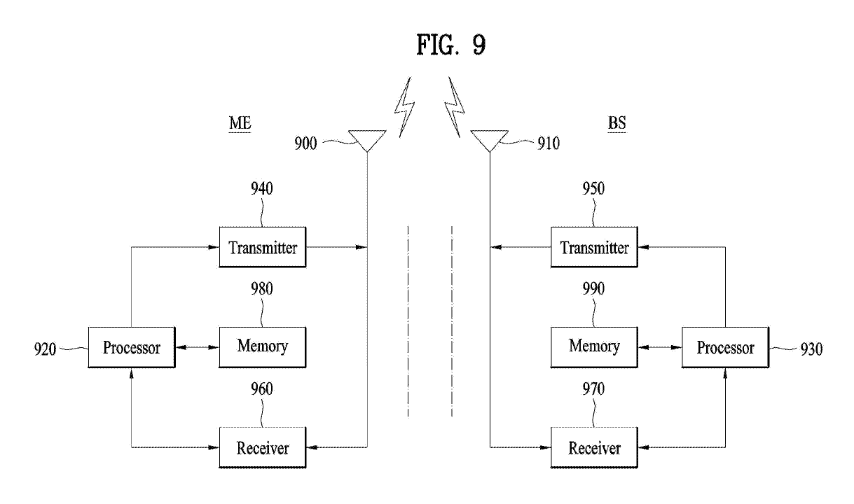

FIG. 9 shows apparatuses for implementing the above-mentioned methods described with reference to FIGS. 1 to 8.

A ME can serve as a transmitter on uplink and as a receiver on downlink. An eNB can serve as a receiver on uplink and as a transmitter on downlink.

The ME and the eNB may include a transmitter 940 and 950 and receiver 960 and 970 for controlling transmission and reception of signal, data and/or messages and antennas 900 and 910 for transmitting and receiving signal, data and/or messages, respectively.

In addition, the ME and the eNB may respectively include processors 920 and 930 for performing the above-described embodiments of the present invention and memories 970 and 990 for storing processing procedures of the processors temporarily or continuously.

The embodiments of the present invention can be performed using the aforementioned components and functions of the ME and the eNB. The apparatuses shown in FIG. 9 may be one of members illustrated in FIGS. 1 and 2.

The processor 920 of the ME may be configured to transmit the preference setting information by controlling the transmitter to the eNB which is one of parts of the terminating network. The receiver of the ME may receive the call message including the caller ID and/or the trust level information. The processor of the ME further configured to display the caller ID and/or the trust level information according to the preference level information.

The processor 930 of the eNB can perform the authentication procedure for verifying the incoming call has been spoofed or not. In addition, the memory of the eNB is able to store the preference setting information and the user information of the users.

The transmitter 940 and 950 and the receiver 960 and 970 included in the ME and the eNB can have packet modulation and demodulation functions, a fast packet channel coding function, an OFDMA packet scheduling function, a TDD packet scheduling function and/or a channel multiplexing function. In addition, the ME and the eNB may further include a low-power radio frequency (RF)/intermediate frequency (IF) module.

In the embodiments of the present invention can use a personal digital assistant (PDA), a cellular phone, a personal communication service (PCS) phone, a global system for mobile (GSM) phone, a wideband CDMA (WCDMA) phone, a mobile broadband system (MBS) phone, a hand-held PC, a notebook PC, a smart phone, a multi-mode multi-band (MM-MB) terminal or the like as the ME.

Here, the smart phone is a terminal having advantages of both a mobile communication terminal and a PDA. The smart phone can be a mobile communication terminal having scheduling and data communication functions including facsimile transmission/reception, internet access, etc. of the PDA. The MM-MB terminal means a terminal including a multi-modem chip, which can be operated in both a portable Internet system and a mobile communication system (e.g., CDMA 2000 system, WCDMA system, etc.).

The exemplary embodiments of the present invention may be achieved by various means, for example, hardware, firmware, software, or a combination thereof.

In a hardware configuration, the exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the exemplary embodiments of the present invention may be achieved by a module, a procedure, a function, etc. performing the above-described functions or operations. Software code may be stored in a memory unit and executed by a processor. The memory unit may be located at the interior or exterior of the processor and may transmit and receive data to and from the processor via various known mean.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

The embodiments of the present invention may be applied to various wireless access systems. The wireless access systems include 3GPP, 3GPP2 and/or IEEE 802.xx (Institute of Electrical and Electronic Engineers 802) system, etc. The embodiments of the present invention may be applied to technical fields using the various wireless access systems in addition to the wireless access systems.

What is claimed is:

1. A method for managing a preference setting for trust level information of a caller identifier in a wireless access network, the method performed by a mobile equipment (ME) and comprising:
transmitting preference setting information of a user of the ME to the network, the preference setting information indicating whether or not the trust level information for an incoming call from a caller is to be delivered; and
receiving a call message including the caller identifier of the caller, the call message being configured based on the preference setting information,
wherein the call message further includes the trust level information when the preference setting information indicates the trust level information is to be delivered, or the call message dose not includes the trust level information when the preference setting information indicates the trust level information is not to be delivered.

2. The method according to claim 1, the preference setting information is only stored in the network.

3. The method according to claim 1, the ME determines to display or not the trust level information according to the call message.

4. The method according to claim 1, further comprising:
transmitting user information including an identifier of user to a network when the ME has been powered on,
wherein the user information is stored in the network along with the preference setting information of the user.

5. The method according to claim 4, wherein the call message is configured based on the user information along with the preference setting information of the user.

6. The method according to claim 1, wherein the trust level information indicates one of (1) fully authenticated, (2) spoofed, or (3) not authenticated.

7. A mobile equipment (ME) for managing a preference setting for trust level information of a caller identifier in a wireless access network, the ME comprising:
a transmitter;
a receiver; and
a processor connected with the transmitter and the receiver for managing the preference setting information,
wherein the processor is configured to:
transmit preference setting information of a user of the ME to the network by controlling the transmitter, the preference setting information indicating whether or not the trust level information for an incoming call from a caller is to be delivered; and
receive a call message including the caller identifier of the caller by controlling the receiver, the call message being configured based on the preference setting information, and
wherein the call message further includes the trust level information when the preference setting information indicates the trust level information is to be delivered, or the call message dose not includes the trust level information when the preference setting information indicates the trust level information is not to be delivered.

8. The ME according to claim 7, the preference setting information is only stored in the network.

9. The ME according to claim 7, the processor determines to display or not the trust level information according to the call message.

10. The ME according to claim 7, wherein the processor is further configured to:
transmit user information including an identifier of the user to a network when the ME has been powered on by controlling the transmitter,
wherein the user information is stored in the network along with the preference setting information of the user.

11. The ME according to claim 10, wherein the call message is configured based on the user information along with the preference setting information of the user.

12. The ME according to claim 7, wherein the trust level information indicates one of (1) fully authenticated, (2) spoofed, or (3) not authenticated.
